(19) United States
(12) Patent Application Publication
(10) Pub. No.: US 2019/0054700 A1
(43) Pub. Date: Feb. 21, 2019

(54) Machine learning for additive manufacturing

(71) Applicant: Cincinnati Incorporated, Harrison, OH (US)

(72) Inventors: Arjun Chandar, North Miami, FL (US); Alfonso Perez, Orlando, FL (US); Eric Hagemeyer, Roswell, GA (US); Pantelis Gkaliamoutsas, Somerville, MA (US); Shien Yang Lee, Johor Bahru (MY); Yuanhan James Xu, Boston, MA (US)

(21) Appl. No.: 15/998,461

(22) Filed: Aug. 15, 2018

Related U.S. Application Data
(60) Provisional application No. 62/545,644, filed on Aug. 15, 2017.

(51) Int. Cl. B29C 64/393; B33Y 50/02; B29C 64/118

(52) U.S. Cl. CPC B29C 64/393; B33Y 10/00; B29C 64/118; B33Y 50/02

(57) ABSTRACT

An additive manufacturing system includes performing at least one first 3D printing process to at least partially manufacture an artifact, measuring at least one measured dimension of the at least partially manufactured artifact, and comparing the at least one measured dimension to at least one corresponding nominal dimension to provide at least one comparison. The process also includes generating at least one regression model in response to the at least one comparison.

### CROSS-REFERENCE TO RELATED APPLICATION

This application claims the benefit of U.S. Provisional Patent Application Ser. No. 62/545,644 filed Aug. 15, 2017, the disclosure of which is incorporated by reference herein in its entirety.

### FIELD OF THE INVENTION

The present invention relates generally to additive manufacturing systems and methods and, more particularly, to additive manufacturing systems having machine learning for providing error compensation.

### BACKGROUND OF THE INVENTION

The manufacturing systems widely known as 3D printers operate based on a class of manufacturing techniques known as additive manufacturing. Additive manufacturing differs from subtractive processes (e.g., conventional machining, grinding, lapping) and net-shape processes (e.g., casting, bending, spinning) by incrementally depositing material to achieve desired part geometry. The modern additive manufacturing industry subsumes numerous technologies ranging from selective laser sintering (SLS) to layered object manufacturing (LOM). One of the most widely use forms of additive manufacturing technology is fused filament fabrication (FFF) also known as Fused Deposition Modeling (FDM). Dimensional accuracy remains a significant shortcoming of 3D printers when it comes to tolerance-critical parts. The significant temperature changes, long process times (on the order of hours for the majority of parts), and serial nature of 3D printing presents a complex constellation of challenges to the production of dimensionally accurate parts.

Fused Filament Fabrication (FFF), also known as Fused Deposition Modeling (FDM), is a 3D additive manufacturing process whereby a thermoplastic is extruded through a nozzle as a semi-molten filament and is deposited on to a print bed. Extruder temperature refers to the temperature measured on the thermal block to which the nozzle is thermally coupled. The thermal block-nozzle assembly may be heated by a resistive heating element with feedback for closed-loop temperature control provided by an embedded thermistor. The relationship between extruder temperature and layer thickness is expected to be mediated by visco-elastic and thermal phenomena such as creep and shrinkage, which are affected by changes in spatial and temporal temperature profiles within the part. The extrusion head of the FDM machine typically moves in the x (left-right) and y (front-back) axes depositing layers of material. Once the horizontal layer is extruded, the bed shifts in the z (vertical) axis thus allowing for the next layer to be deposited on top of the preceding layer. Depending on the geometry of the printed part, support material and infill material will need to be added to keep the print from failing. The added material also keeps the part from warping and provides the finished product with extra tensile strength. Once the part has been printed, it is often manually removed and the support material is removed by hand or dissolved in a water-based solution. Depending on the required finish or specified feature geometries of the part it might require post machining before it can be put to its intended use. Extrusion width refers to the width of the material bead deposited by the FFF machine during printing. Solid regions of a part are made up of multiple linear beads of material deposited adjacent to each other. Extruder offset refers to the nominal distance between the tip of the extrusion nozzle and the top of the previously deposited layer. Under normal operation, the 3D printer controller sets extruder offset equal to the nominal slice thickness. An increase in extruder offset (i.e., nozzle tip further away from build surface) is expected to increase layer thickness by reducing the degree of vertical constriction experienced by the extruded bead.

The design of a part is performed using Computer Aided Software (CAD). The CAD file is then converted into a (STL) part file. From the end user's perspective, the 3D printer or 3D printer software takes STL files as inputs and generates physical parts. The STL file format is commonly used in the additive manufacturing industry to represent three-dimensional geometry. Internally, STL files describe a collection of triangular facets which collectively comprise one or more three-dimensional surfaces. Each triangular facet is described by the coordinates of its three vertices in 3-space and an additional three dimensional normal vector used to represent orientation. In practice, STL files are typically generated by computer-aided design (CAD) software as tessellated approximations to smooth 3D geometry. In order to 3D print an STL part file, the file must be sliced. STL files submitted are used to generate instructions that govern the physical motion of the printer through a process known as “slicing”. Based on the 3D printer and part parameters, the material used, and the slicer settings, a slicer configuration is established. The deposited bead of material is idealized as a prismatic structure with a rounded-corner rectangle cross-section. Ideally, this calculation would cause layer thickness to be invariant against changes in the specified extrusion width. However, the validity of these idealizing assumptions is expected to vary depending on extrusion width and, producing a relationship between extrusion width and the actual thickness of deposited layers. During the slicing step, the enclosed volume described in the STL file is sliced into a set of finite-thickness planar layers. Slice thickness refers to the nominal thickness of these layers. In order to conserve material and shorten cycle time, the internal volume of 3D printed parts are typically supported by lattice-like infill structures instead of being filled completely. In the case of FDM or FFF, these infill structures are also generated during the slicing step and incorporated into the G-code file. These internal features are difficult to measure after printing and are ideally measured during the 3D printing process. The slicer packages used can usually calculate the volume of molten material to extrude over each print move based on the length of the print move, thickness of the layer, and extrusion width. Using this configuration, the STL file is converted into a sliced part file before being translated into G-code (in the case of FDM or FFF). In the case of other 3D printing processes, analogous computer control algorithms exist, for example BITMAP. G-code is a numerical control programming languages that sends commands to the printer in order to print a part. Commands include actuating speed, feed rate of material, x and y nozzle position, and print bed z position. G-code is a programming language widely used to control a wide variety of computer numerical controlled (CNC) systems. A G-code file comprises an ordered set of lines which are interpreted and executed sequentially at run time. Each line begins with an alphanumerical “code” that instructs the machine to perform a specific action. This code may be followed by one or more whitespace-separated “arguments” which establish parameters for the prescribed action. A large number of codes, including system-specific and manufacturer-specific variants, exist. However, the most common instructions used in FFF systems are instructions for linear motions described by the codes “G0” and “G1”. For example the line “G1 X1 Y1 Z1 E5 F100” instructs the printer to move from its current position to the point h1, 1, 1i at a rate of 100 mm/min while extruding 5 mm of filament. Machine state adjustments such as temperature changes and axis homing are also prescribed by lines in the G-code file. The 3D printer interprets these commands and builds the part.

Thus, it would be desirable to provide a 3D printer that achieves improved dimensional accuracy abilities without greatly increasing the price of the 3D printer and by avoiding major hardware changes. An improvement in dimensional accuracy and consistency would elevate the quality of 3D printing as a manufacturing process. This is desirable due to the impending need for greater printer dimensional accuracy.

### SUMMARY

In one embodiment, an additive manufacturing process includes performing at least one first 3D printing process to at least partially manufacture an artifact, measuring at least one measured dimension of the at least partially manufactured artifact, and comparing the at least one measured dimension to at least one corresponding nominal dimension to provide at least one comparison. The process further includes generating at least one regression model in response to the at least one comparison. In one embodiment, measuring at least one measured dimension of the at least partially manufactured artifact includes manually measuring at least one measured dimension of the at least partially manufactured artifact. For example, manually measuring at least one measured dimension of the at least partially manufactured artifact may include using at least one of a coordinate measuring machine (CMM), a caliper, or a tape measurer. Alternatively, measuring at least one measured dimension of the at least partially manufactured artifact may include automatically measuring at least one measured dimension of the at least partially manufactured artifact. For example, automatically measuring at least one measured dimension of the at least partially manufactured artifact may include using at least one of a coordinate measuring machine (CMM), machine vision, computer vision, 3D scanning, 2D scanning, or probing.

In one embodiment, measuring at least one measured dimension of the at least partially manufactured artifact is performed while performing the at least one first 3D printing process. Alternatively, measuring at least one measured dimension of the at least partially manufactured artifact may be performed after performing the at least one first 3D printing process.

The additive manufacturing process may further include adjusting at least one machine code command in response to the at least one regression model, and may also include performing at least one second 3D printing process in response to the at least one adjusted machine code command. For example, the at least one adjusted machine code command may include at least one G-code command. In addition or alternatively, performing at least one second 3D printing process may include further manufacturing the at least partially manufactured artifact. In another embodiment, performing at least one second 3D printing process includes at least partially manufacturing a second artifact. In addition or alternatively, generating at least one regression model may include generating at least one of a linear regression, a logistic regression, a polynomial regression, a loglinear regression, a power regression, an exponential regression, a logarithmic regression, a stepwise regression, a ridge regression, a lasso regression, or an elastic net regression.

In another embodiment, an additive manufacturing process includes providing a 3D part file, generating a machine code from the 3D part file for sending commands to a 3D printer in order to print a part, and executing the machine code via the 3D printer to at least partially manufacture the part. The process also includes measuring at least one measured dimension of the at least partially manufactured part, comparing the at least one measured dimension to at least one corresponding nominal dimension to provide at least one comparison, and adjusting the machine code in response to the at least one comparison. The machine code may be G-code. In one embodiment, generating a machine code from the 3D part file includes slicing the 3D part file, and may further include translating the sliced 3D part file.

In another embodiment, an additive manufacturing process includes providing a 3D part file, generating a machine code from the 3D part file for sending commands to a first 3D printer in order to print a part, and executing the machine code via the first 3D printer to at least partially manufacture the part. The process also includes measuring at least one measured dimension of the at least partially manufactured part, comparing the at least one measured dimension to at least one corresponding nominal dimension to provide at least one comparison, and generating at least one regression model in response to the at least one comparison. In one embodiment, the process further includes communicating the at least one generated regression model to a second 3D printer, and may also include manufacturing a second part via the second 3D printer in response to the at least one generated regression model.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, serve to explain the one or more embodiments of the invention.

FIG. 1 is a schematic showing the nominal layer thickness, tₙₒₘ, vs. the actual average layer thickness, \dot{t}, and the height of the part, Hₜₒₜₐₗ, based on the layer thickness quantization in FDM printing, wherein n defines the number of layers in the part.

FIG. 2A is a flowchart which describes the general 3D file to machine code software workflow for 3D printers

FIGS. 2B-2D are illustrations of the efficacy of error compensation approaches at various stages of the software workflow for 3D printing.

FIG. 3 is a flowchart illustrating sources of error prediction uncertainty in 3D printers.

FIG. 4 is a 3D visualization depicting the difference between layer based compensation for z-direction accuracy improvement and full 3D compensation for z-direction accuracy improvement.

FIG. 5 is a flowchart demonstrating the methodology and technique for layer thickness error compensation.

FIG. 6A illustrates a methodology for measuring layer thickness error in a 3D printed part.

FIG. 6B is a perspective view of a 3D printed sample.

FIG. 7 is a flowchart demonstrating the applicability of error mapping and compensation on 3D printing output.

FIG. 8A is a rendering of an error mapping artifact comprising multiple cylindrical columns designed based on design heuristics and having a solid base for measurement fixturing.

FIG. 8B is a rendering of an error mapping artifact comprising multiple cylindrical columns designed based on design heuristics and having V groves designed for kinematic coupling for measurement fixturing.

FIGS. 9A and 9B provide a 3D visualization of standard deviation of predicted height errors across 5 real models derived from repeat measurements of a single artifact.

FIG. 10 is a flowchart illustrating a process according to an embodiment of the invention.

FIG. 11 is a diagrammatic view of a computer that may be used to implement one or more of the components and/or processes shown and/or described herein.

### DETAILED DESCRIPTION OF THE INVENTION

FDM or FFF is just one of many 3D printing or additive manufacturing processes. Other processes include, but are not limited to, SLA, SLS, DMLS, WAAM, nano lithography etc. The data measurement, processing, and accuracy correction techniques described herein apply to any and all types of 3D printing machines or additive manufacturing machines. The rest of this disclosure will be described in the context of the FDM or FFF process workflow and variable, however, it must be noted that to those skilled in the art each different 3D printing or additive manufacturing process can be altered and benefit from improved part accuracy using the techniques disclosed herein.

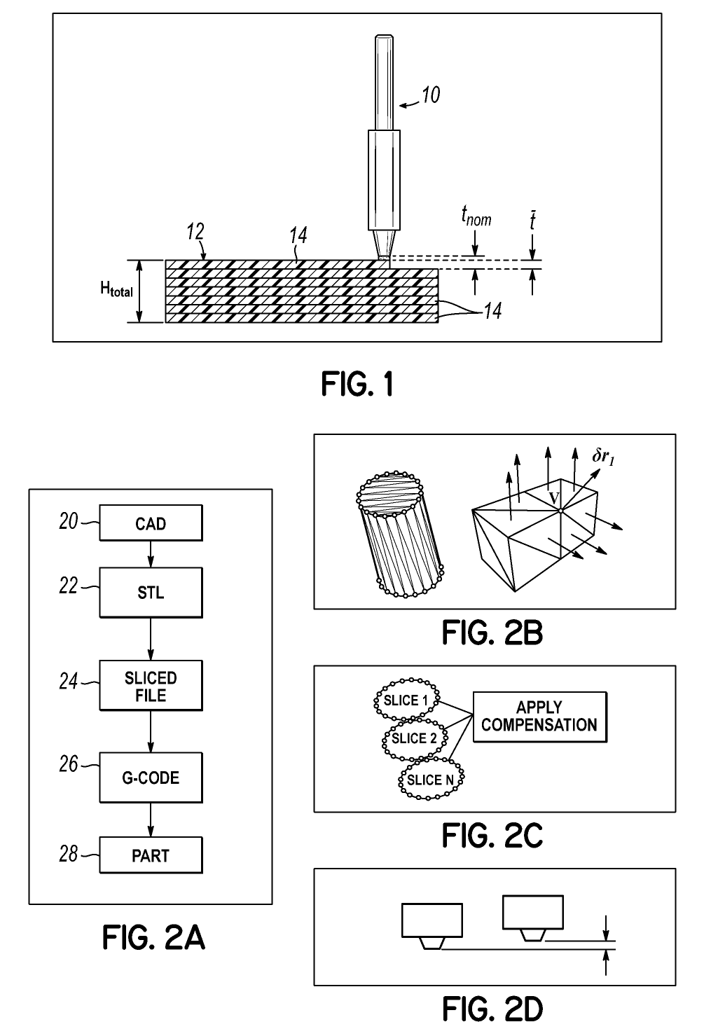

With reference now to FIG. 1, an FFF system 10 is shown producing a printed part 12 by printing a number n of layers 14 with a nominal or desired layer thickness tₙₒₘ, an actual average layer thickness \dot{t}, and a total height of the part 12, Hₜₒₜₐₗ. The resolution of the FFF system 10 determines the smallest feature that can be rendered in the printed part 12. Resolution is primarily controlled by the width (extrusion width) and height (slice thickness) of the smallest bead the system 10 is able to extrude. The repeatability of the FFF system 10 measures the consistency with which it can reproduce satisfactory parts over time. In a multi-machine environment, repeatability could also include consistency across different machines used to produce similar parts. Accuracy is measured by the degree by which the manufactured part 12 deviates from nominal part geometry specified in the design file used to generate the toolpath. The dimensional accuracy of the FFF system 10 is influenced by several interacting phenomena, including motion control errors and thermally induced shrinkage or warpage. For example possible 3D printer parameters to be controlled may include, but are not limited to, build height, infill density, infill structure, print quality (nominal layer thickness, extrusion speed, nozzle speed), and print material. Errors can arise between the G-code commands sent to the 3D printer and the actual actions of the 3D printer, causing dimensional inaccuracies in part height. The layer thickness setting may be important as it affects the adhesion of the part as well as the resolution of the 3D printer. The build height, across which the layer thickness measurements are taken, may be important in determining a relationship over the 3D printer's full z-axis operating range. Build height refers to the total height Hₜₒₜₐₗ of the printed part 12.

PLA layer distortions in FDM printing contribute to layer thickness variation. Thermal stresses and strains of the PLA form as it is extruded at a hot temperature and is rapidly cooled to ambient temperature. The variation can be explained by the variability in cooling time between layers 14 at different heights of the part 12. At higher nominal layer thicknesses tₙₒₘ, the overall cooling rate is lower and less controlled. Less control of cooling rates in the FDM process can cause unpredictable viscoelastic effects in the part 12 causing it to be inaccurate. Elastic effects, due to gravitational pressures from stacked material, are also present. However, these effects may be negligible in comparison to the effects caused by viscoelastic behavior.

With reference now to FIG. 2A, the general software workflow for FDM 3D printers is illustrated in a flowchart form. The blocks represent the code file formats of the representation of the part as well as the finished part. There are 5 main steps illustrated as CAD 20, STL file 22, sliced file 24, G-code file 26, and part 28. These steps can be generalized to full features 3D model, representation of the 3D model, pre-machine code sliced file, machine code, and 3D printed part, respectively. The diagram of FIG. 2A demonstrates the potential intervention points in the software tool chain needed to improve the accuracy of the 3D printing process.

With reference now to FIGS. 2B-2D, a diagram of the various techniques that can be used to improve the accuracy of the 3D printing process at each step in the software workflow of FIG. 2A is shown. During the “representation of 3D model” or STL step 22 of the process flow shown in FIG. 2A, a z-discretization technique can be used where the overall 3D model is scaled by a set percentage or estimated percentage, as shown in FIG. 2B. Thus, the improvement may be limited by z-discretization. During the “pre-machine code sliced file” or sliced file step 24 of the process, the accuracy can be improved by selecting a smaller layer thickness or layer height, as shown in FIG. 2C. Thus, the improvement may be toolchain-specific. During the “machine code” or G-code step 26 of the process the machine code may be modified by incremental, and theoretically infinitesimal, amounts in order to improve the accuracy of the 3D printed part, as shown in FIG. 2D. This may enable improvement down to motion resolution.

With continuing reference to FIGS. 2A-2D, the Grey Taguchi Method may be used to improve dimensional accuracy of the FDM process. The effect of five printer setting factors on three dimensional accuracy is examined. The factors include layer thickness, part build orientation, raster angle, air gap, and raster width. To fully correct for FDM inaccuracies, optimal factor level settings may be found that do not solely take into consideration significant effects. The use of the Grey Taguchi method allows combining the goals of reducing inaccuracies of all dimensions into a single objective known as the grey relation grade. Maximizing this relation provides optimal factor level settings for dimensional accuracy. A lower layer thickness ultimately reduces the percentage change in height of the part whilst also increasing errors in the x and y dimensions. Actual printed layer thickness is typically below the expected layer thickness stated in the print settings.

In addition, layer thickness may be the most significant factor to part dimensional accuracy, whilst the interaction between factors infill density and extrusion speed are significant for surface roughness. Thermal shrinkage may be a major source of dimensional error in parts manufactured by FFF. Some existing commercial FFF systems attempt to reduce the effect of shrinkage on dimensional accuracy by applying a shrinkage compensation factor (SCF) to the input part geometry.

A robust relationship between build height and layer thickness variation can aid in the creation of an accurate compensation model. A more insidious source of height error may arise from systematic (nonrandom) deviations of actual deposited layer thicknesses from the theoretical slice thickness. Over a large number of layers (FFF parts may have between tens and thousands of layers), even small systematic deviations could accumulate and produce substantial errors in the overall height of the part or position of height-critical features.

Error compensation strategies for 3D printing can also be categorized based on where geometric adjustments are injected along the toolchain leading from CAD data to finished part. Dimensional error compensation may be applied immediately following the design phase. Depending on the design workflow, this may take place either at the level of CAD files 20 or after CAD data has been exported into STL files 22. Intervening at this early stage is often computationally convenient as the abstract geometric representations used in CAD and STL file formats lend themselves well to geometric transforms. Compensatory adjustments applied to STL files prior to slicing are subjected to limits in the adjustment resolution available. During slicing, continuous part geometry is converted into planar layers. For an uncompensated part, a quantization error which could be as large as half the nominal slice thickness is introduced. When height error compensation is applied prior to slicing 24, adjustments are liable to be absorbed by this quantization procedure, leading to greater-than-expected residual errors in the compensated part. This limits the performance of interventions at the CAD stage 20 or STL stage 22.

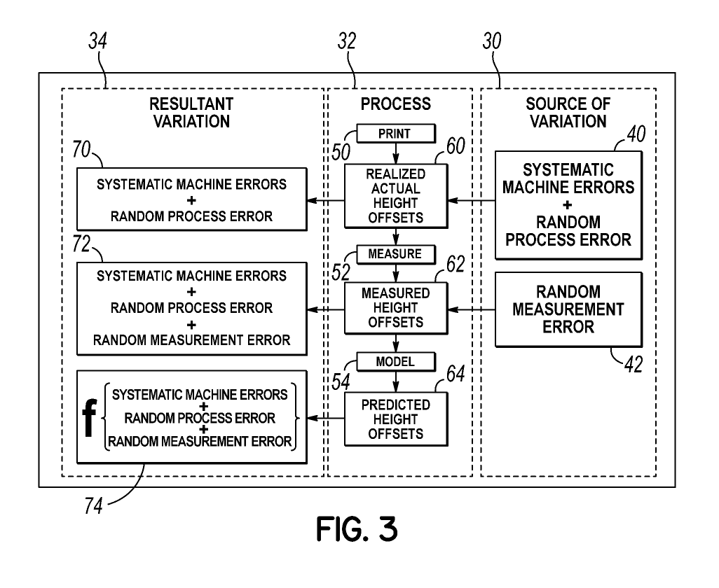

With reference now to FIG. 3, the illustrated diagram can be broken into three main sections: sources of variation 30, process 32, and resultant variation 34. For example, sources of variation 30 include but are not limited to systematic machine errors and random process errors 40, and measurement errors 42. The process 32 can be broken into three main steps: 3D print 50, measure 52, and model 54. The benefit of 3D printing the part 50 is to realize the actual dimensional accuracy offsets 60. The benefit of measuring the part 52 is to have real or approximate values of the actual measured part 62. Lastly, the measured 3D printed part can be used to create a model 54 which serves to predict dimensional inaccuracies for future parts 64, which allows for improving the accuracy of subsequently 3D printed parts. The resulting variation observed by 3D printing the part 50 is due to a combination of systematic machine errors and random process errors 70. The resulting variation observed by measuring the 3D printed part 52 is due to a combination of systematic machine errors, random process errors, and random measurement errors 72. Lastly, the resulting variation observed by modeling the 3D printing error process 54 is a function of the combination of systematic machine errors, random process errors, and random measurement errors 74. Scaling adjustments that change target height by less than the slice thickness are eliminated by rounding to the closest integral number of layers during slicing. Therefore, shrinkage compensation with a constant scaling factor may not reliably reduce height accuracy below half the slice thickness. Further improvements in height accuracy may require intervention at a more granular level. The limitations of a uniform overall error compensation factor imposes an upper bound to the amount of performance improvement attainable. An important limitation of such implementations, which apply shrinkage compensation as a uniform scaling transform, is that they can only reliably correct the spatially uniform component of dimensional deviation due to shrinkage. For example, spatially varying dimensional deviations due to viscoelastic effects cannot be fully corrected by a uniform scaling correction—intermediate features will remain in incorrect positions even if the scaling results in the correct overall part size. A finer-grained approach to height error compensation is desired. To date, uniform thickness slicing algorithms remain the dominant approach in the industry.

The primary risk associated with attempts to reduce systematic dimensional errors using model-based compensation stems from uncertainty in error model parameters due primarily to confounding by the random component of dimensional error. This uncertainty introduces a risk of worsening dimensional accuracy at certain points on the part (adverse effects). This risk can be mitigated by averaging out the effect of random dimensional deviations either through replication or through the collection of error data in excess of that required to fit a given error model. Both of these mitigation strategies work by providing an estimate of random dimensional deviation, thereby allowing it to be separated from the systematic component of dimensional deviation targeted by error compensation schemes. Since print failure may be precipitated by a sufficiently large error at a single point—even if the compensation scheme improves dimensional accuracy on average—the marginal risk introduced by an intervention of this type is primarily governed by the worst-case or upper-bound compensation error. De-risking the disclosed error mapping and compensation scheme may require a robust quantification of the upper-bound error prediction uncertainty expected from the error model.

This disclosure enables modelling the accuracy error of the printer and providing compensation methods and models to improve the dimensional accuracy of 3D printers. Accuracy refers to how close the measured value is to the nominal or true expected value. In the case of z-dimensional accuracy this refers to the error in height between the actual measured part and the nominal height set by the slicer. Precision refers to how close the measured values are to each other, i.e. the variation between two similar parts. In order to increase precision of the 3D printer, 3D printing process noise will have to be reduced to get consistent part geometries. Increasing accuracy on the other hand requires a shift in the mean measured values of the part heights in order to approach a height error of zero.

Dimensional errors observed along the height direction in FDM or FFF 3D printed parts are most likely caused by deviations of the nozzle from the nominal position assumed by slicing and machine control algorithms. According to an aspect of the invention, modifications to nozzle position are an effective means to apply error compensation factors to improve height dimensional accuracy of extrusion 3D printers. The potential upside from dimensional accuracy improvement using a model-based compensation approach is expected to be bounded since compensation approaches are limited to reducing the systematic component of dimensional errors—random dimensional errors cannot be directly mapped and compensated for.

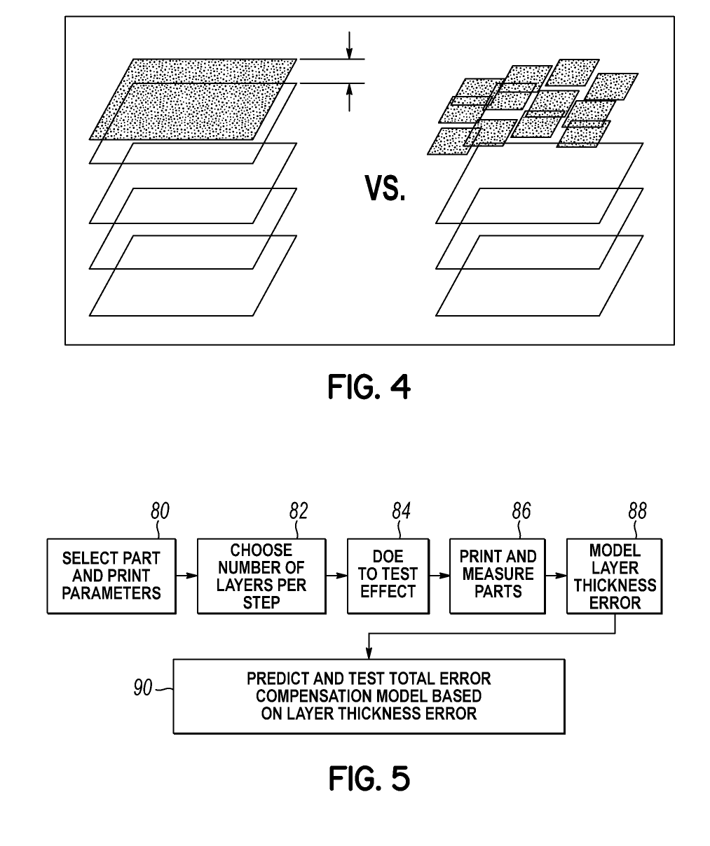

With reference now to FIG. 4, a 3D visualization depicts the difference between layer based compensation for z-direction accuracy improvement on the left-hand side of the figure and full 3D compensation for z-direction accuracy improvement on the right-hand side of the figure. According to an embodiment of the invention, the modeling and prediction of total height error of a 3D printed part is addressed using a layer-by-layer approach. A height error compensation model is formulated and applied at a G-code level (or other relevant machine code such as bitmap, for example) to drive the 3D printer machine to 3D print parts with improved dimensional accuracy. This may include a model that effects the various inputs to a 3D printer and printed part parameters on the layer thickness variation for different qualified printer materials. The layer thickness variation ultimately affects the printed total part height accuracy.

At least two approaches are disclosed herein. One approach is map height error in all three dimensions across the build envelope. By mapping the error, a 3D compensation model can be formulated and tested using a software based compensation method to try and increase the part height accuracy of the 3D printer. The second accuracy approach tackles height dimensional accuracy by modeling variations in layer thickness along the height of a part. The second approach involves testing the layer to layer thickness error, across the entire z-dimension, against a variety of print materials, build heights, infill structures, infill densities, and print qualities. By modeling the layer thickness error (LTE) across these parameters, a compensation model can be derived to increase the accuracy of parts printed with varying settings. The z-dimensional accuracy can then be improved through feedforward compensation of layer thickness variation. The tools and procedures developed are intended to be easily generalizable to address dimensional errors in all three (breadth, depth, and height) directions. In addition, these tools and procedures are designed to be hardware-agnostic (i.e., easily applicable to 3D printers other than G-code based FDM systems).

Both height error reduction strategies described above may require a way to adjust the thicknesses of individual layers by manipulating one or more control inputs. While a single control input may be sufficient to manipulate layer thickness, in practice it is desired to have access to multiple control inputs to allow layer thickness adjustments while maintaining other quality characteristics (e.g. XY dimensional accuracy) within acceptable limits. Successful implementation of a layer-based error compensation strategy requires not only the identification of appropriate control inputs, but also a quantitative understanding of how changes in control inputs affect layer thickness.

Given inaccuracies with part dimensions, two methods of compensation are disclosed. Cycle-to-Cycle (CtC) feedback is the process by which changes are made to the process after measuring the part, once a cycle is complete. This methodology can be implemented at a layer-by-layer level when it comes to FDM. Once the printer completes the deposition of one layer (one cycle), the current part height can be measured, and compensation can be applied to the next layer. This method repeats until the part is complete. The largest obstacle in implementation of CtC is that major hardware changes would need to be made to accurately use this strategy. It is most practical to measure parts after a 3D printing process is complete. However, this invention also discloses the use of machine vision, computer vision, 3D scanning, 2D scanning, probing, and other in process measurement techniques in lieu of post process measurement techniques such as a coordinate measuring machine (CMM), calipers, tape measurer, etc. Taking a computer vision, layer to layer approach can allow the 3D printer to adjust its G-code commands to compensate for errors in part height. The print bed is commanded to adjust from its nominal layer thickness movements in order to compensate for the error. The number of layers is kept consistent to the originally sliced part, but the nominal layer thickness is constantly being adjusted during the part build.

With reference now to FIG. 5, a flow chart demonstrates an overall process or technique according to an embodiment of the invention. The process includes selecting the desired 3D model or design to be 3D printed and approximately configuring the settings of the 3D printer to the desired level to satisfactorily produce the part 80. Next, the 3D printer is configured to produce the desired number of layers on the 3D part 82. Then an experiment is designed to capture the effect of each setting on the desired part 84. The parts are 3D printed to complete the experiment and the 3D printed parts are measured 86. The measured values of the 3D printed parts are used to calculate and model the dimensional error 88. The total error compensation model may then be predicted and tested 90. This error compensation scheme may correct not only mechanical errors associated with the machine, but also capture the part-invariant component of height errors associated with the 3D printing process. Considering both machine and process errors, each with systematic and random components, the actual height error realized in a particular error mapping artifact is expected to be a mixture of these effects. In order to capture this more general form of height error, generic polynomial models may be used instead of kinematic error models. The disclosed 3D height error mapping and compensation scheme—and indeed any error mapping scheme that relies on observation of an artifact produced by the machine—may involve a fundamental trade-off between improvement of mean performance (i.e., reduced systematic errors) and worsening of process variance (i.e., increased random errors). Assuming no systematic biases in the measurement process, the disclosed error mapping and compensation scheme may completely eliminate systematic height errors (mean shift).

In order to utilize the quadratic LTE model, the total part height error prediction can be used to add compensation to the part. With the modeled compensation, the accuracy of the printed parts increases. A model-based (feedforward) error compensation strategy that does not require hardware modifications to the printer could improve the height accuracy of the 3D printer. This strategy involves first capturing the systematic component of layer thickness variation as a function of various process parameters (error mapping and modelling), then applying a geometric offset based on the deviation predicted by the model (error compensation). Since such strategies involve thickness adjustments to individual layers, it has the potential to improve the height accuracy throughout the build height.

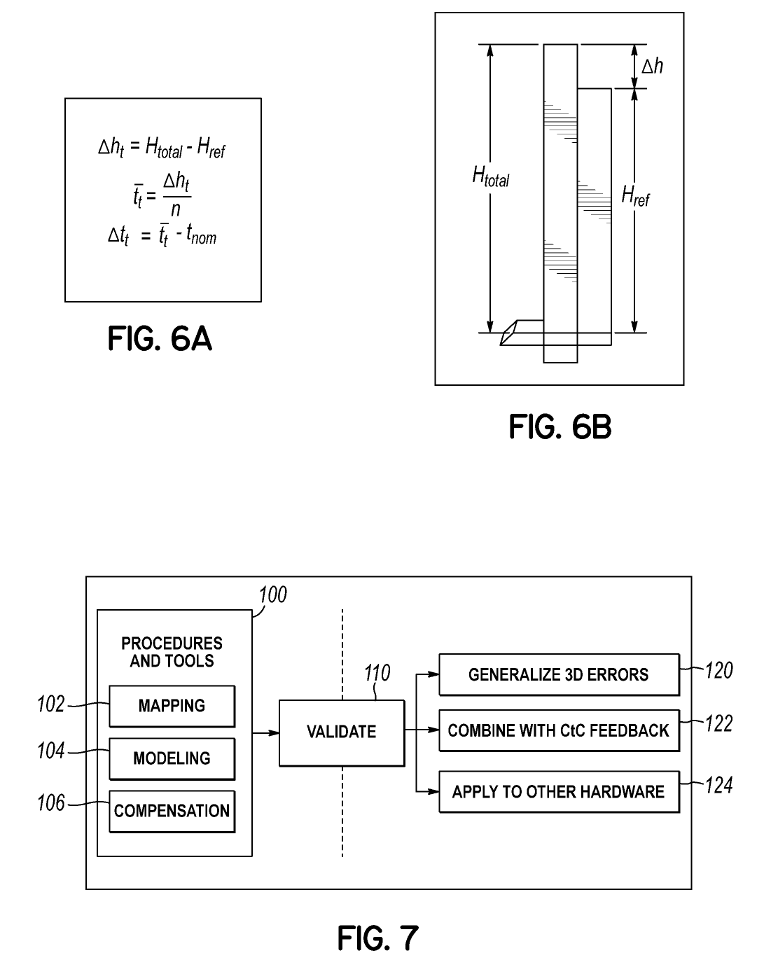

With reference now to FIGS. 6A and 6B, the z-dimensional accuracy of an FDM printer is based on the consistency in extruded layer thickness as layers are stacked on top of each other. Because layers are of fixed thickness values in the software, the actual part height is not necessarily quantized to plus or minus that value. For example, if the layer thickness in the slicer settings is set to 0:3 mm and a 5 mm part is being made, the slicer may over compensate by adding an additional layer which will push the part height to 5:1 mm, thus making the part height divisible by the nominal layer height of 0:3 mm. Yet even parts that are designed to account for such deviations are quite often inaccurate in the z-dimension as is shown in FIG. 1. Modeling the reason for this inaccuracy allows for adoption of corrective systems for variations in the layer thickness. If implemented correctly, this ultimately leads to repeatable production of highly accurate parts.

In order to calculate the error in layer thickness, an extra step may be taken to calculate the average thickness of a layer contained within the measured step size. By taking the distance between the reference plane and the top plane (Δh) and dividing it by the nominal number of layers (n) output by the G-code, the average layer thickness (\dot{t}ₜ) can be found at that build height over the given step size. This number can then be subtracted from the nominal layer thickness, given by the slicer configuration, to arrive at the average LTE.

Moreover, careful selection of the point of intervention may avoid limitations imposed by discretization on error compensation strategies. The provided layer thickness approach yields dependable results for PLA parts and can be easily implemented to a variety of 3D printers and 3D print materials that have consistent print qualities. This disclosure also provides a methodology that may be generalized and applied to various 3D printers that use altering 3D print settings and 3D print materials.

With reference now to FIG. 7, a flow chart describes the process used to actually implement these compensation strategies on physical 3D printers. The invention disclosed in this application focuses mainly, but not entirely, on the first step of the flow chart shown in FIG. 7, procedures and tools 100. The procedures and tools 100 may be categorized as mapping procedures and/or tools 102, modelling procedures and/or tools 104, and compensation procedures and/or tools 106. The next step in the process to actually implement these techniques in a physical 3D printer is to validate 110 the mapping procedures, mapping tools, modelling procedures, modelling tools, compensation procedures, and compensation tools by running a thorough experiment or series of experiments which demonstrate the accuracy improvement. Once the process has been validated 110, the next step is to generalize the results to 3D errors (in contrast to a single dimension as described previously) 120, combine the process and methods disclosed herein with cycle to cycle feedback control techniques common in industry 122, and to generalize the findings to apply to other types of 3D printers 124. The last step of the process may require additional validation as the results are generalized in three dimensions, as cycle to cycle feedback control is implemented, or as the techniques are applied to additional types of 3D printers.

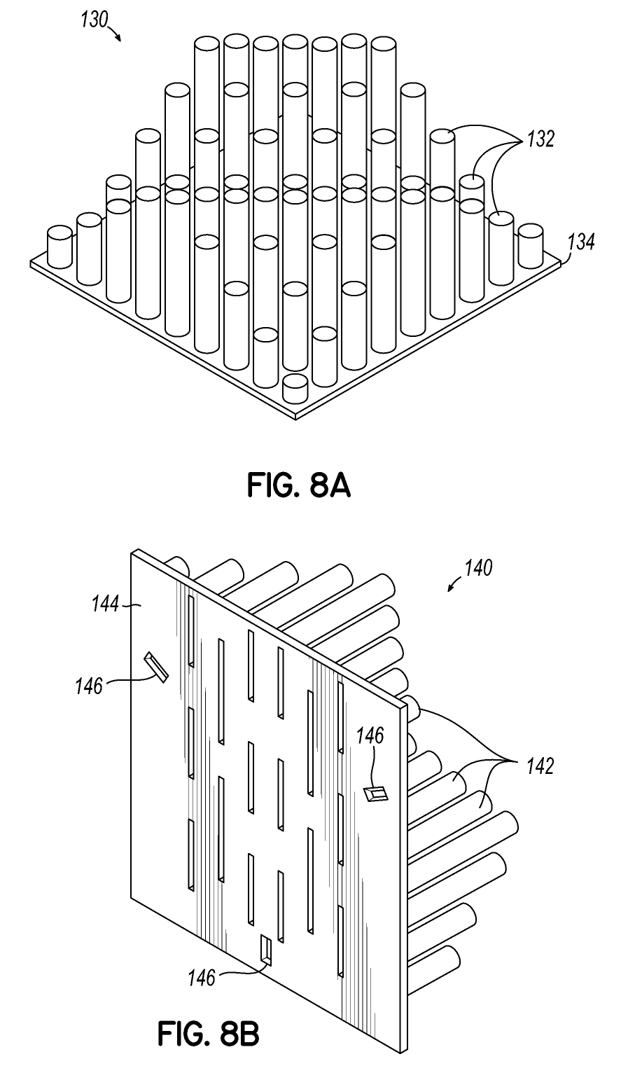

With continuing reference to FIG. 7, an artifact-based height error mapping and compensation method for fused filament fabrication machines and other additive manufacturing machines (“3D printers”) is provided. In the provided method, an error mapping artifact (see FIGS. 8A and 8B) is produced and inspected using a coordinate measuring machine to determine height errors at 81 discrete points in the machine's work envelope. The artifact does not need to be the 81 features artifact. It can be any 3D printed geometry produced by the machine or a similar machine and having any suitable number of features for determining dimensional errors. A polynomial regression model is fitted to this measured data and used to generate height error predictions at each point in the volume of novel parts. The regression model does not need to be polynomial, but rather can be any type of regression model. Finally, height error compensation based on the aforementioned model is applied by modifying G-code sequences used to drive the machine. The provided method is capable of reducing systematic height errors and spatial dependence of height errors over the work volume studied.

The provided scheme may include the design of a 3D height error mapping artifact, a measurement procedure oriented to a CMM, a data analysis and error model fitting procedure implemented in MATLAB, and software tools for application of 3D height error compensation to G-code files implemented as a Python library. It should be noted that the 3D height error mapping artifact can be any arbitrary 3D printed object and reference 3D model to compare measurements. It should be noted that the measurement procedure may be in 3D printing process or after the 3D printing process, using a physical measurement technique or digital technique such as machine vision or computer vision. It should be noted that the implementation does not need to be in MATLAB, G-code, or python, but rather any other suitable programming language substitutes are acceptable and are within the scope of this invention.

The process of error compensation can be approximated as a subtraction of predicted height error from a realization of uncompensated height error,

ΔH_{comped}=ΔH_{uncomped}−ΔH_{pred}

where ΔH_{comped}, ΔH_{uncomped}, and ΔH_{pred} denote height error after compensation, height error before compensation, and predicted height error, respectively. This approximation may not be strictly accurate as it assumes the compensation process does not alter height variance, but is nevertheless adequate for characterizing the potential adverse effects of applying error compensation. Assuming individual height error observations and height error predictions are independently distributed, the variance of residual height error after compensation is

σ_{comped2}=σ_{obs2}+σ_{pred2}

where σ_{comped2}, σ_{obs2}, σ_{pred2} denote the variances of height error after compensation, height error before compensation, and predicted height error, respectively.

With reference now to FIG. 8A, a first error mapping artifact 130 comprising multiple cylindrical columns 132 extending from a base 134 may be designed based on design heuristics. The arrangement of columns 132 may allow sufficient space for the measurement instrument (e.g., a CMM probe) to access the top free surface of each column 132 while distributing treatment levels in a manner that yields a satisfactory experimental design. The same artifact 130 may be used to capture errors in the X- and Y-directions by simply augmenting the measurement procedure. In the case where the measurement technique is not a physical or probing technique, for instance but not limited to computer vision, the features may be separated by at least the resolution of the recording device. Direct clamping of the artifact 130 to the surface plate using screws may substantially deform the reference base and cause it to conform to the CMM surface plate. This may not only artificially diminish the effect of warpage on height error—biasing the resultant error model—but may also occur to varying degrees between setups due to the variable clamping load applied by manually torqued fasteners.

Referring now to FIG. 8B, a second error mapping artifact 140 comprising multiple cylindrical columns 142 extending from a base 144 allows the artifact 140 to be mounted for measurement on the CMM surface plate via a kinematic coupling or mechanical interfaces that exerts exact constraint on the bodies coupled together, thereby allowing reversible location of components relative to each other with high precision. For example, a Maxwell coupling may be used to fixture the 3D error mapping artifact 140 for measurement. Three generally V-shaped grooves 146 are incorporated into the base 144 of the error mapping artifact 140. These grooves 146 open to the underside of the artifact 140 and have their included angle configured to allow printing without support material. The V grooves 146 on the error mapping artifact 140 are configured to mate with corresponding balls on the fixturing plate (not shown), thereby coupling the two bodies together. Each inclined face of a V groove 146 may contact a ball at a single point, providing a total of six point contacts that exactly constrain the artifact 140 relative to the fixturing plate. Preload to keep the coupling engaged may be supplied exclusively by the weight of the artifact 140, thereby eliminating most or all variability otherwise introduced by manual clamping. The relatively lower measurement repeatability of the first artifact 130, with no kinematic coupling contacts, may be caused by a combination of fixturing variability and warpage in the thick base 134 used as the primary datum. The incorporation of kinematic fixturing capabilities into the second error mapping artifact 140 leads to a substantial reduction in measurement noise and an improved compensation algorithm. Due to the unavoidable contamination of measured height data by random height variation, selection of model form may consider the trade-off between adequately capturing systematic spatial patterns of height error and over-fitting to random height errors realized on a single artifact.

Each artifact 130, 140 produced by a machine is a single sample from the population of possible artifacts that could be produced by that machine. Information about a machine's systematic errors contained in printed artifacts is contaminated by random (non-systematic) errors. The problem is further exacerbated by any additional uncertainty introduced by the measurement process. Fitting a polynomial error model imposes smoothness and continuity conditions that subjects this variance relationship to a mathematical transformation but does not introduce additional uncertainty.

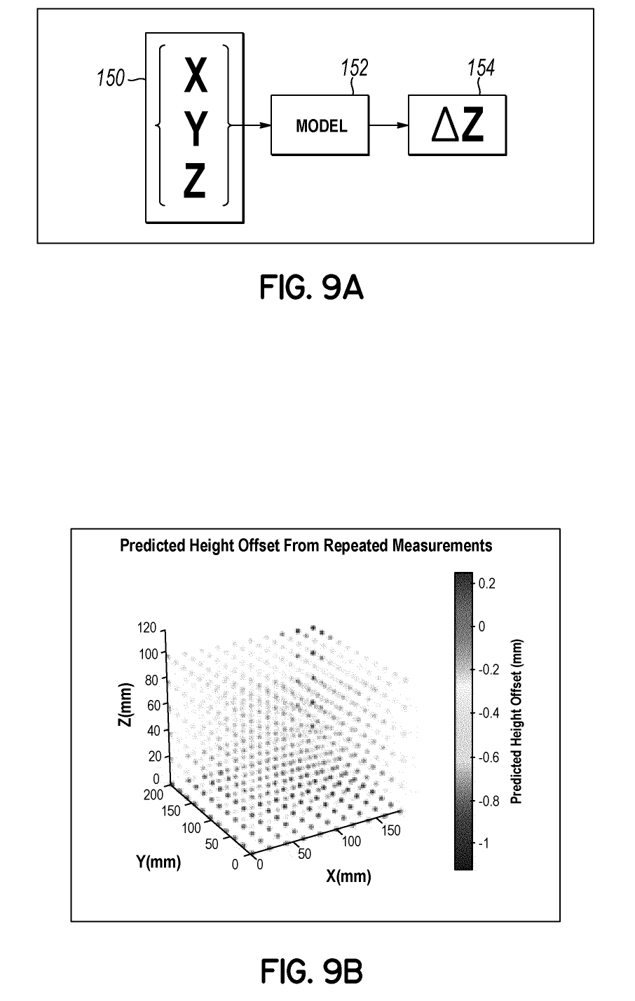

With reference now to FIG. 9A, a flow chart describes the mathematical or algorithmic technique according to an embodiment of the invention to create an error map of each 3D printer's build volume or build envelope at every known or discernable location within the 3D printer. For example, FIG. 9A illustrates the technique for applying a Z-compensation at each XYZ coordinate. First, each XYZ coordinate in the 3D printer's build envelope is identified 150. Next, each XYZ coordinate is processed using the error compensation model 152. Lastly, each XYZ coordinate has a Z-compensation attributed to it 154. This process can also be generalized to X-compensation and Y-compensation. This process can be completed using three similar techniques or reduced to one more sophisticated technique which computes simultaneously.

With reference now to FIG. 9B, a diagram of a 3D visualization of standard deviation of predicted height errors across five real models derived from repeat measurements of a single artifact is shown. This is an example, derived from real measured data, intended to help visualize the mathematical technique described and depicted in FIG. 9A.

With continuing reference to FIGS. 9A and 9B, the disclosed 3D height error compensation scheme may modify the 3D printer instructions (e.g., G-code commands in the case of FDM or FFF) sent to the machine to describe geometrically morphed motions which realize nominal part geometry when executed by a machine with systematic height errors. The error compensation process may be viewed as a geometric transform acting on print moves (points and edges) described in the G-code file. Another compensation technique is based on feedforward control, which works by compensating a part before it is 3D printed. This assumes that some prior knowledge of the part and process exists that can make an intelligent prediction of error. This control strategy is often model based. The model may take many forms, not just linear or polynomial. In order to determine the sensitivity of the predicted total part height error using the quadratic model, prediction intervals are calculated and transformed to fit the predicted total error model. Prediction intervals provide the limits of future predicted values from a model given a new model input value to a specific confidence level. The invention also allows for different types of regressions and combinations of regressions to be used such as, but not limited to, linear regression (for example between response and input variable(s) Y=a+b*X), logistic regression (for example dependent variable is a probability P or logarithm of probability ln(P) against input variables and may be used for cases when the desired response is a binary function with probability of success P. Y=success, p=P(Y), log it(p)=ln(p/(1−p)), log it(p)=a+b*X), polynomial regression (for example used when the response/input relationship can be better expressed through a polynomial of input variables than with a linear regression. Y=a+b*X̂n), loglinear or power regression (for example used when the response/input relationship can be better expressed through a power of input variables. Y=a*X̂b OR ln(Y)=A+b*ln(x)), exponential regression (for example Y=a*ê(b*X) or ln(Y)=A+b*X), logarithmic regression (for example Y=a+b*ln(X) or êY=A*X̂b), stepwise regression (for example this is used when there are multiple independent variables which may or may not affect response. Stepwise regression models add or remove variables after each data point based upon whether a variable in question improves prediction accuracy), ridge regression (for example used when input variables are highly correlated to each other, causing high variances in a linear regression; adds a penalty or shrinkage factor to the sum of squares of all coefficients and adds it to the model, to reduce prediction variance), lasso regression (for example similar to ridge regression, but uses absolute values of coefficients in its shrinkage factor instead of sum of squares, which means some variables may be subtracted out in the final model; may be used for a similar purpose as stepwise regression, to minimize input variables), elastic net regression (for example which is a combination of benefits of Lasso regression and Ridge regression). It is also important to note that other suitable regression models may be used and are within the scope of this invention. Any one regression models or combination of models are considered part of the invention.

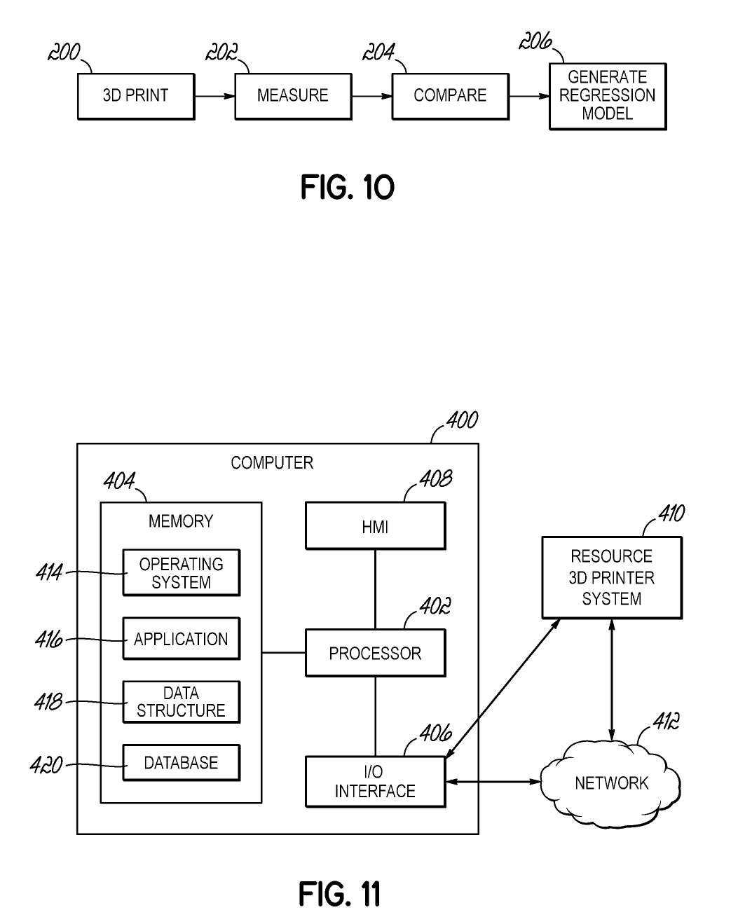

Referring now to FIG. 10, an embodiment of the invention includes the process of 3D printing an artifact (using one or multiple 3D printing processes to create a specific or arbitrary 3D part) 200, measuring said artifact during or after 3D printing (using a manual measurement technique such as a CMM or an automated measurement technique such a machine vision) 202, comparing a measured dimension to a corresponding nominal dimension 204, and producing a corresponding regression model (one or multiple models can be used) 206. An embodiment of the invention may also include the use of machine learning algorithms such as, but not limited to, natural language processing algorithms to process the machine code (for example in FDM, GCode). An embodiment of the invention may also include the use of machine learning algorithms for model training from the processing of in-process measurement data (for example real time measurements using machine vision or computer vision can be used to constantly update the regression model(s)).

Another embodiment of the invention includes methods of providing 3D printing error compensation which introduce geometric offsets that depend on location within the work volume. Such methods may correct both spatially uniform and spatially varying dimensional errors, as long as they are systematic in nature. The spatial error models generated through these processes may dictate the amount of compensation or offset to be applied at each point within the part volume.

Firmware-level instructions for each print may be contained in a single G-code file. Each linear printing move is described by a G0 or G1 command which defines the coordinates of a destination position, a length of filament to extrude over the move, and optionally, a feed rate to use for the move. Since all input part models are represented in the STL file format, curved geometries are approximated by multiple linear segments, resulting in purely linear print moves in the G-code file. During FFF or FDM 3D printing, commands in the G-code file are interpreted sequentially by the motion planner and used to move the printer nozzle along the path defined by the sequence of destination points. In keeping with the layer-by-layer deposition sequence used by the majority of FFF systems, unmodified G-code groups print moves that take place at the same height (Z-dimension) into the same “layer”. Movements along the Z-axis are only explicitly specified during layer transitions, and the Z coordinate is omitted from commands for individual print moves, defaulting to the last-set value specified at the beginning of each layer. In addition, due to the assumption of planar layers, straight edges are typically rendered with long linear print moves.

The height error model contains significant curvature which may not be conducive to being exactly described using only straight line segments. Therefore, the error compensation routine first iterates through all printing moves in the G-code file and splits print moves longer than 3 mm into 3 mm-long segments, for example. The 3 mm threshold may represent an acceptable trade-off between dimensional fidelity and the size of the resulting G-code file after compensation, but other suitable threshold values may be used. For example, this distance may be changed to an optimal segmentation length based upon the specific 3D printer and the specific 3D printing process. After move segmentation, application of height error compensation entails offsetting the destination point of each print move (or print move segment) along the Z-direction to counteract the systematic height error predicted by the 3D error model at the corresponding location. This error compensation algorithm was designed to be easily adaptable to error mapping and compensation along X, Y, and Z directions. In this generalized case, the print move splitting step will remain the same while each point undergoes a vector offset in 3D space in place of the scalar offset along the Z-direction. This error compensation algorithm depends only on a function that produces an error vector for each point in space, allowing it to be agnostic to the internal workings of the error model. For example, the provided G-code-level error compensation algorithm is equally compatible with kinematic error models (also known as volumetric error models) as it is with generic polynomial error models.

Error compensation can also be applied as modifications to the G-code file which defines the tool paths. Each 3D print head move is represented as a line of G-code specifying the coordinates of a destination position, the target feed rate for the move, as well as the length of filament to extrude. This instructs the machine controller to move the extruder from the current position to the destination position using the target feed rate while extruding the specified length of filament. Modifying the coordinates of the destination positions described in G-code allows direct application of error compensation that directly translates to changes in nozzle position and the volume of material extruded. The main advantage of applying error compensation directly to the G-code is the degree of fine adjustment it allows. Compensation applied at the G-code level is not subjected to tessellation or discretization errors, unlike adjustments applied prior to slicing. In fact, the smallest dimensional adjustment possible using this compensation approach is limited only by the motion control resolution of the hardware involved (e.g., a single step of a stepper motor). This allows a large number of small adjustments to be distributed across the part volume, as opposed to a small number of “lumped” adjustments, thereby increasing conformance of compensated part geometry to the original design intent geometry. This is especially useful for parts with complex geometry or multiple critical features, where error compensation is required to improve dimensional accuracy without introducing local distortions.

The program iterates through layers, extracts the uncompensated layer height for each layer, queries the error model an error prediction, and modifies the layer height to counteract the predicted height error. This compensation routine does not necessarily take the spatial resolution of the 3D printer's motion control system into account. It may specify layer height values to the computer's floating point precision. When the modified G-code is sent to print, the motion control system approximates specified bed positions with discrete steps of the Z-axis stepper motor. A more sophisticated understanding of height error in the 3D printer can be achieved by construction of a three-dimensional map of height errors. With a sufficiently detailed error map, compensation can theoretically be applied to eliminate errors in all six kinematic degrees of freedom. For explanation purposes this disclosure focuses on reducing height error and does not specifically address dimensional errors in the X and Y directions. However, the contents of this disclosure may be readily generalized to a true volumetric error compensation solution that addresses systematic errors in all six kinematic degrees of freedom.

It will be appreciated that the disclosed 3D height error compensation scheme requires no hardware changes to the 3D printer. In addition, the disclosed error mapping process is based on a printed artifact instead of direct measurement of machines, allowing it to be easily adapted to other 3D printer systems. The software tools disclosed to enable 3D height error compensation operate at the G-code level, which confers compatibility with FFF systems based on Cartesian motion systems. Application to hardware with non-cartesian motion systems (e.g., Delta arm robots) may require minor modification of the source code to accommodate differences in the way print moves are represented. Nevertheless, the algorithm for application of height error compensation based on functional error maps remain applicable regardless of hardware details. The procedures and tools developed can be readily generalized by persons skilled in the art to address systematic width and depth errors in addition to height errors without modifying the design of the error mapping artifact. The disclosed procedures and tools may be tested across multiple printers by producing multiple parts with compensation applied. Inclusion of multiple printers may establish the degree to which the disclosed procedure is robust against hardware variations while replication of compensated parts may provide insights on the effect of the intervention on height accuracy over time.

Referring now to FIG. 11, embodiments of the invention described above, or portions thereof, may be implemented using one or more computer devices or systems, such as exemplary computer 400. The computer 400 may include a processor 402, a memory 404, an input/output (I/O) interface 406, and a Human Machine Interface (HMI) 408. The computer 400 may also be operatively coupled to one or more external resources 410 via the network 412 and/or I/O interface 406. External resources may include, but are not limited to, servers, databases, mass storage devices, peripheral devices, cloud-based network services, or any other resource that may be used by the computer 400, such as a 3D printer system. In this regard, it will be appreciated that the computer 400 or one or more of the processor 402 (or components thereof) or other illustrated components could be provided in a separate system or may be incorporated directly into the existing control system of the 3D printer system.

The processor 402 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 404. Memory 404 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, and/or data storage devices such as a hard drive, optical drive, tape drive, volatile or non-volatile solid state device, or any other device capable of storing data.

The processor 402 may operate under the control of an operating system 414 that resides in memory 404. The operating system 414 may manage computer resources so that computer program code embodied as one or more computer software applications, such as an application 416 residing in memory 404, may have instructions executed by the processor 402. In an alternative embodiment, the processor 402 may execute the application 416 directly, in which case the operating system 414 may be omitted. One or more data structures 418 may also reside in memory 404, and may be used by the processor 402, operating system 414, or application 416 to store or manipulate data.

The I/O interface 406 may provide a machine interface that operatively couples the processor 402 to other devices and systems, such as the external resource 410 or the network 412. The application 416 may thereby work cooperatively with the external resource 410 or network 412 by communicating via the I/O interface 406 to provide the various features, functions, applications, processes, or modules comprising embodiments of the invention. The application 416 may also have program code that is executed by one or more external resources 410, or otherwise rely on functions or signals provided by other system or network components external to the computer 400. Indeed, given the nearly endless hardware and software configurations possible, persons having ordinary skill in the art will understand that embodiments of the invention may include applications that are located externally to the computer 400, distributed among multiple computers or other external resources 410, or provided by computing resources (hardware and software) that are provided as a service over the network 412, such as a cloud computing service.

The HMI 408 may be operatively coupled to the processor 402 of computer 400 in a known manner to allow a user to interact directly with the computer 400. The HMI 408 may include video or alphanumeric displays, a touch screen, a speaker, and any other suitable audio and visual indicators capable of providing data to the user. The HMI 408 may also include input devices and controls such as an alphanumeric keyboard, a pointing device, keypads, pushbuttons, control knobs, microphones, etc., capable of accepting commands or input from the user and transmitting the entered input to the processor 402.

A database 420 may reside in memory 404, and may be used to collect and organize data used by the various systems and modules described herein. The database 420 may include data and supporting data structures that store and organize the data. In particular, the database 420 may be arranged with any database organization or structure including, but not limited to, a relational database, a hierarchical database, a network database, or combinations thereof. A database management system in the form of a computer software application executing as instructions on the processor 402 may be used to access the information or data stored in records of the database 420 in response to a query, which may be dynamically determined and executed by the operating system 414, other applications 416, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

While the present invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The present invention in its broader aspects is therefore not limited to the specific details and illustrative examples shown and described. Accordingly, departures may be made from such details without departing from the scope of the general inventive concept.

What is claimed is:

1. An additive manufacturing process, comprising:
performing at least one first 3D printing process to at least partially manufacture an artifact;
measuring at least one measured dimension of the at least partially manufactured artifact;
comparing the at least one measured dimension to at least one corresponding nominal dimension to provide at least one comparison; and
generating at least one regression model in response to the at least one comparison.

2. The additive manufacturing process of claim 1, further comprising using the at least one regression model to compensate for a predicted dimensional error during at least one second 3D printing process.

3. The additive manufacturing process of claim 1, wherein measuring at least one measured dimension of the at least partially manufactured artifact includes manually measuring at least one measured dimension of the at least partially manufactured artifact.

4. The additive manufacturing process of claim 1, wherein measuring at least one measured dimension of the at least partially manufactured artifact includes automatically measuring at least one measured dimension of the at least partially manufactured artifact.

5. The additive manufacturing process of claim 4, wherein automatically measuring at least one measured dimension of the at least partially manufactured artifact includes using at least one of a coordinate measuring machine (CMM), machine vision, computer vision, 3D scanning, 2D scanning, or probing.

6. The additive manufacturing process of claim 1, wherein measuring at least one measured dimension of the at least partially manufactured artifact is performed while performing the at least one first 3D printing process.

7. The additive manufacturing process of claim 1, wherein measuring at least one measured dimension of the at least partially manufactured artifact is performed after performing the at least one first 3D printing process.

8. The additive manufacturing process of claim 1, further comprising:
adjusting at least one machine code command in response to the at least one regression model.

9. The additive manufacturing process of claim 8, further comprising:
performing at least one second 3D printing process in response to the at least one adjusted machine code command.

10. The additive manufacturing process of claim 9, wherein the at least one adjusted machine code command includes at least one G-code command.

11. The additive manufacturing process of claim 9, wherein performing at least one second 3D printing process includes further manufacturing the at least partially manufactured artifact.

12. The additive manufacturing process of claim 9, wherein performing at least one second 3D printing process includes at least partially manufacturing a second artifact.

13. The additive manufacturing process of claim 1, wherein generating at least one regression model includes generating at least one of a linear regression, a logistic regression, a polynomial regression, a loglinear regression, a power regression, an exponential regression, a logarithmic regression, a stepwise regression, a ridge regression, a lasso regression, or an elastic net regression.

14. An additive manufacturing process, comprising:
providing a 3D part file;
generating a machine code from the 3D part file for sending commands to a 3D printer in order to print a part;
executing the machine code via the 3D printer to at least partially manufacture the part;
measuring at least one measured dimension of the at least partially manufactured part;
comparing the at least one measured dimension to at least one corresponding nominal dimension to provide at least one comparison; and
adjusting the machine code in response to the at least one comparison.

15. The additive manufacturing process of claim 14, wherein the machine code is G-code.

16. The additive manufacturing process of claim 14, wherein generating a machine code from the 3D part file includes slicing the 3D part file.

17. The additive manufacturing process of claim 16, wherein generating a machine code from the 3D part file further includes translating the sliced 3D part file.

18. An additive manufacturing process, comprising:
providing a 3D part file;
generating a machine code from the 3D part file for sending commands to a first 3D printer in order to print a part;
executing the machine code via the first 3D printer to at least partially manufacture the part;
measuring at least one measured dimension of the at least partially manufactured part;
comparing the at least one measured dimension to at least one corresponding nominal dimension to provide at least one comparison; and
generating at least one regression model in response to the at least one comparison.

19. The additive manufacturing process of claim 18, further comprising communicating the at least one generated regression model to a second 3D printer.

20. The additive manufacturing process of claim 19, further comprising manufacturing a second part via the second 3D printer in response to the at least one generated regression model.
